(19) United States
(12) Patent Application Publication
(10) Pub. No.: US 2021/0064816 A1
(43) Pub. Date: Mar. 4, 2021

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Yuji YONEDA, Kanagawa (JP)

(73) Assignee: FUJI XEROX CO., LTD., Tokyo (JP)

(21) Appl. No.: 16/781,030

(22) Filed: Feb. 4, 2020

(30) Foreign Application Priority Data
Sep. 3, 2019 (JP) 2019-160685

(51) Int. Cl. G06F 40/174; G06K 9/00; G06K 9/03

(52) U.S. Cl. CPC G06F 40/174; G06K 2209/01; G06K 9/03; G06K 9/00449

(57) ABSTRACT

An information processing device includes a processor configured to output an extracted character string entry rule for each item of a form in a case where a regularity related to an entry of a character string of a confirmation result is extracted, the confirmation result being a result of confirming a result of character recognition performed on the form.

### CROSS-REFERENCE TO RELATED APPLICATIONS

This application is based on and claims priority under 35 USC 119 from Japanese Patent Application No. 2019-160685 filed Sep. 3, 2019.

### BACKGROUND

### (i) Technical Field

The present disclosure relates to an information processing device and non-transitory computer readable medium.

### (ii) Related Art

Japanese Unexamined Patent Application Publication No. H03-291777 discloses a recognition candidate character output control method of a character recognition device. The character recognition device recognizes each character recorded onto a paper medium and read using an optical means as groups of pixels in units of characters, and outputs first candidate character groups, which contain multiple characters having a possibility of being correct characters that match characters expressed by the groups of pixels, in order of a probability of being extracted as correct characters arbitrarily set in advance. The method includes: supplying a character code of each character in the output first candidate character groups to a recognition candidate character storing means that stores in the above order, and to a second candidate character storing means that stores a total count extracted as a correct character and a number of occurrences corresponding to the order with regard to the characters extracted as correct characters from the first candidate character groups stored in the recognition candidate character storing means, and additionally, on the basis of the total count and the number of occurrences stored in the second candidate character storing means, selecting a second candidate character group having a high probability of being extracted as the correct characters from a candidate character string stored in the recognition candidate character storing means; extracting correct characters specified manually from the selected second candidate character group; and recognizing an order of occurrence of the correct characters in the recognition candidate character storing means, and correcting the number of occurrences total count extracted as the correct characters corresponding to the order of occurrence of the correct characters in the second candidate character storing means.

Japanese Unexamined Patent Application Publication No. H06-36069 discloses a character recognition device for storing format control information referenced to read characters and the like recorded on a page. The character recognition device includes: a format control information storing means in which information specifying a character type in the format control information is expressed as a regular expression; a regular expression analyzing means that analyzes the regular expression in the format control information stored in the format control information storing means; and a reading means that computes a reading result for the characters and the like recorded on the page, on the basis of a result of the analysis by the regular expression analyzing means.

Japanese Unexamined Patent Application Publication No. H09-35006 discloses an optical recognition device provided with: a character statistical information creation unit that creates character statistical information about a form; a standard pattern dictionary containing standard patterns that express features of characters; a standard pattern dictionary changing unit that changes the content of the standard pattern dictionary on the basis of the character statistical information; and a character recognition unit that compares a character pattern to be recognized to the standard patterns in the standard pattern dictionary to perform character recognition of the character pattern.

### SUMMARY

To raise the certainty factor of the result of character string recognition by an optical character recognition (OCR) process, a form designer who has designed a form to be read by the OCR process examines what type of content is entered by users in the items of the form, and predicts whether some kind of entry rule exists for the character strings expressing the content. For example, if there is an item for filling in age, it is predicted that numerals will be filled in by the users, and therefore if an entry rule stipulating that numerals will be entered into the age item is set in advance, the age item will be recognized as numerals in the OCR process on the basis of the entry rule. Consequently, even if an ambiguous character string is entered in which the numeral “2” is difficult to distinguish from the letter “Z” for example, the character string will be recognized as the numeral “2”, and the certainty factor of the character string recognition result is raised compared to the case of not setting an entry rule.

However, depending on the item, it may be difficult to predict what kinds of character strings will be entered by users. In such circumstances, if the form designer is unable to make a decision about the entry rule to be set for an item of the form, the form designer may not set an entry rule in some cases, and the certainty factor for the character string recognition result by the OCR process may be lowered because an entry rule is not set for the item of the form.

Aspects of non-limiting embodiments of the present disclosure relate to assistance that enables a form designer to set a character string entry rule for an item of a form, even if the form designer is unable to predict what kinds of character strings will be entered into the item of the form.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing device including a processor configured to output an extracted character string entry rule for each item of a form in a case where a regularity related to an entry of a character string of a confirmation result is extracted, the confirmation result being a result of confirming a result of character recognition performed on the form.

### BRIEF DESCRIPTION OF THE DRAWINGS

An exemplary embodiment of the present disclosure will be described in detail based on the following figures, wherein:

FIG. 1 is a block diagram illustrating an exemplary functional configuration of an information processing device;

FIG. 2 is a diagram illustrating one example of a confirmation and correction table;

FIG. 3 is a diagram illustrating one example of a cumulative count table;

FIG. 4 is a diagram illustrating one example of a pattern table;

FIG. 5 is a diagram illustrating an exemplary schematic configuration of an electrical system in the information processing device;

FIG. 6 is a flowchart illustrating one example of an extraction process;

FIG. 7 is a flowchart illustrating one example of an output process;

FIG. 8 is a diagram illustrating an example of a screen displayed on a display unit;

FIG. 9 is a diagram illustrating another example of a screen displayed on a display unit;

FIG. 10 is a diagram illustrating another example of a screen displayed on a display unit;

FIG. 11 is a flowchart illustrating an exemplary modification of an extraction process; and

FIG. 12 is a flowchart illustrating one example of a change notification process.

### DETAILED DESCRIPTION

Hereinafter, an exemplary embodiment will be described with reference to the drawings. Note that the same structural elements and the same processes are denoted with the same signs throughout all drawings, and duplicate description is omitted.

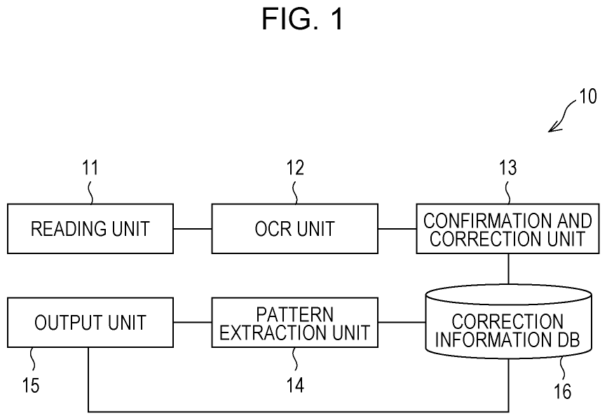

FIG. 1 is a block diagram illustrating an exemplary functional configuration of an information processing device 10 that confirms and corrects a recognition result of a character string read from an image of a form generated by optically reading the content of the form, stores the confirmed and corrected recognition result in a storage device, and extracts and outputs a character string entry pattern from the stored confirmed and corrected result of the character string.

A “form” refers to a document in which information about specific matters is entered in accordance with a predetermined format, and includes entry fields into which a person filling out the form enters content for each item, for example. An “item” refers to an attribute expressing content entered into an entry field, such as the address and name of the person filling out the form for example. Items are identified by a title recorded for each entry field. A character string entered into an entry field may be handwritten or printed type using a printer or the like. Also, there are no restrictions on the types of forms processed by the information processing device 10. It is sufficient for a form to be provided with an entry field for each item and for a person filling out the form to enter content corresponding to each item. For example, the form may be an application, a contract, or a questionnaire.

In the following, a character string entered into the entry field of an item on a form by the person filling out the form is referred to as the “character string corresponding to the item”. Also, the term “character string” means a series of one or more characters.

As illustrated in FIG. 1, the information processing device 10 includes functional units, namely a reading unit 11, an OCR unit 12, a confirmation and correction unit 13, a pattern extraction unit 14, and an output unit 15, as well as a correction information database (DB) 16.

The reading unit 11 uses a scanner unit 30 for example to optically read the content of a form filled out by a person, and creates an image of the form. The reading unit 11 supplies the generated image of the form to the OCR unit 12.

The OCR unit 12 executes an OCR process on the received image of the form, and supplies a character string recognition result by the OCR process, or in other words a character recognition result, to the confirmation and correction unit 13. Note that the OCR unit 12 associates a certainty factor with each recognized character string, and supplies the certainty factor to the confirmation and correction unit 13.

Herein, the certainty factor of a recognized character string refers to a value indicating how high the recognition accuracy of the character string is, such as whether or not the character string included in the image of the form has been recognized correctly as filled in on the form. For example, a certainty factor of 100% indicates that the character string has been recognized as filled in on the form, while a certainty factor of 50% indicates that there is a 1-in-2 chance that a character string different from the character string filled in on the form has been recognized.

For example, in the case where the numeral “2” is entered in the image of the form, the OCR unit 12 outputs a character string with the closest shape from among characters registered in a dictionary as the character recognition result, but in the case where the numeral “2” is handwritten and entered with a shape that could also be read as the letter “Z”, the OCR unit 12 may incorrectly output the letter “Z” as the character recognition result for the numeral “2”. In other words, as the number of character strings that resemble the character string to be recognized increases, the probability of incorrectly recognizing the character string rises, and therefore a low certainty factor is associated with the character string.

In this way, because a character string recognized by the OCR unit 12 may be recognized as a different character string from the character string entered by the person filling out the form, a reviewer visually compares the form to the character recognition result by the OCR unit 12 while also referring to the certainty factor to confirm whether each character string has been recognized correctly, and if a character string has not been recognized correctly, the reviewer corrects the recognition result.

In the case where an instruction to correct a character string is received from the reviewer, the confirmation and correction unit 13 corrects the character string recognized by the OCR unit 12 to the character string specified by the reviewer. Also, in the case where an instruction indicating that correction of a character is unnecessary is received from the reviewer, the confirmation and correction unit 13 does not correct the character string recognized by the OCR unit 12. The confirmation and correction unit 13 registers the recognition results of character strings recognized by the OCR unit 12 in the correction information DB 16 for each item of the form, and manages the registered information in a confirmation and correction table 2. Note that the reviewer and the form designer may be the same person or different people.

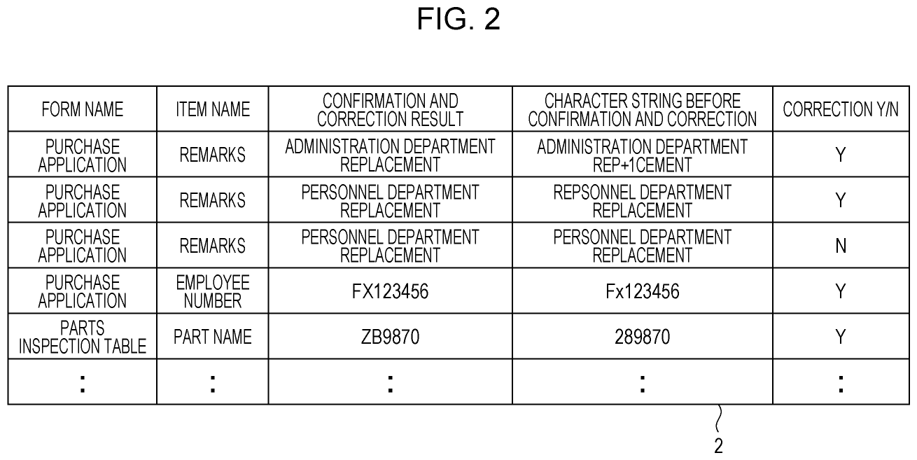

FIG. 2 is a diagram illustrating one example of the confirmation and correction table 2. The confirmation and correction table 2 is a table that includes a “form name” field, an “item name” field, a “confirmation and correction result” field, a “character string before confirmation and correction” field, and a “correction Y/N” field.

In the “form name” field, the name of a form containing character strings to be confirmed by the confirmation and correction unit 13 is set.

In the “item name” field, the title of an item included on the form containing a character string to be confirmed by the confirmation and correction unit 13 is set.

In the “confirmation and correction result” field, a character string that has been confirmed by the confirmation and correction unit 13 is set. In the case where the confirmation result indicates that the character string has been corrected, the corrected character string is set in the “confirmation and correction result” field. Note that a character string that has been confirmed by the confirmation and correction unit 13 may be referred to as a “confirmed character string”. The confirmed character string is one example of a confirmation result character string according to the exemplary embodiment. Also, among the confirmed character strings, a character string that has been corrected by a reviewer may be referred to as a “corrected character string”.

In the “character string before confirmation and correction” field, the character before confirmation, that is, the character string itself recognized by the OCR unit 12 is set.

In the “correction Y/N” field, information expressing whether or not the character string has been corrected by the confirmation and correction unit 13 is set. For example, “Y” is set in the case where the character string has been corrected, and “N” is set in the case where the character string has not been corrected.

In this way, in the confirmation and correction table 2, the character string before confirmation and the character string after confirmation are associated and managed for each item of the form, and the set of information in each field associated in the row direction of the confirmation and correction table 2 is referred to as the “confirmation and correction information”. Note that in confirmation and correction information in which “N” is set in the “correction Y/N” field, the same character string is set in the “confirmation and correction result field” and the “character string before confirmation and correction” field.

Also, the confirmation and correction unit 13 totals the number of pieces of confirmation and correction information registered in the confirmation and correction table 2 for each item of the form, and manages the totals in a cumulative count table 4 stored in the correction information DB 16.

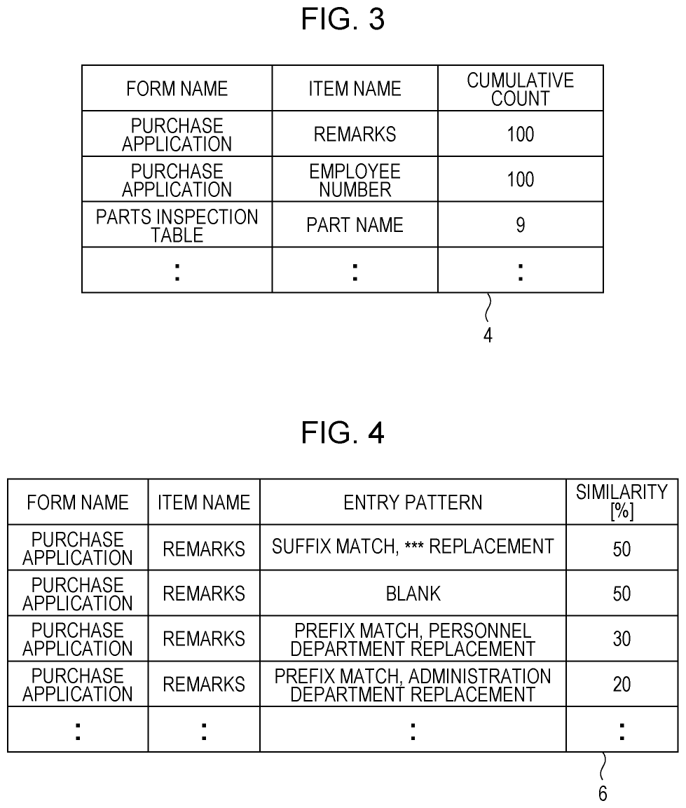

FIG. 3 is a diagram illustrating one example of the cumulative count table 4. The cumulative count table 4 is a table that includes a “form name” field, an “item name” field, and a “cumulative count” field.

In the “form name” field and the “item name” field, the form name and the item name for which the number of pieces of confirmation and correction information is totaled are respectively set.

In the “cumulative count” field, from among the confirmation and correction information registered in the confirmation and correction table 2, the number of pieces of confirmation and correction information corresponding to the item of the form expressed by the content set in the “form name” field and the “item name” field on the same row is set. The number set in the “cumulative count” field corresponds to the number of confirmed character strings collected for an item of a form.

In the case of the cumulative count table 4 illustrated in FIG. 3, it is indicated that the information processing device 10 has accumulated 100 records of the confirmation and correction information of character strings entered into a “Remarks” item of a purchase application in the confirmation and correction table 2, for example. In this way, in the cumulative count table 4, the number of character string confirmation results is stored for each item of a form.

The pattern extraction unit 14 references the confirmation and correction table 2 and the cumulative count table 4 stored in the correction information DB 16 to extract a character string entry rule, or in other words a character string entry pattern, for each item of each form.

A character string entry pattern refers to a regularity in character strings recognized in common in multiple forms. The persons filling out a form are not entering character strings into the items of the form according to a predetermined entry pattern, but because the entry content is limited depending on the item, multiple persons filling out the form unknowingly enter character strings using the same types of expression in some cases. The pattern extraction unit 14 discovers a latent regularity in the confirmed character strings expressed by the content entered into an item, and extracts the discovered regularity as a character string entry pattern.

The correction information DB 16 registers extracted character string entry patterns in the correction information DB 16 and manages the registered entry patterns in a pattern table 6.

FIG. 4 illustrates one example of the pattern table 6. The pattern table 6 is a table that includes a “form name” field, an “item name” field, an “entry pattern” field, and a “similarity” field.

In the “form name” field and the “item name” field, the form name and the item name for which a character string entry pattern has been extracted are respectively set.

In the “entry pattern” field, an entry pattern extracted from the item of the form expressed the content set in the “form name” field and the “item name” field on the same row is set.

In the “similarity” field, a value expressing the degree to which character strings following the entry pattern included on the same row appear in the same item of the same form is set.

In the case of the pattern table 6 illustrated in FIG. 4, it is indicated that an entry pattern “suffix match, *** replacement” appears in a “Remarks” item of a purchase application with a similarity of 50%, for example. Note that the “*” symbol in the entry pattern is a notation denoting any character. Also, a suffix match refers to a character string entry pattern in which the character string matches a designated character string (“replacement” in the case of the above example) when the character string is evaluated successively from the end of the string to the beginning of the string. Conversely, a prefix match refers to a character string entry pattern in which the character string matches a designated character string when the character string is evaluated successively from the beginning of the string to the end of the string. Note that the character string entry pattern is set as a regular expression in the “entry pattern” field, but for the sake of understanding, FIG. 4 illustrates an example in which the content of the regular expression is expressed in words.

A specific method of extracting a character string entry pattern by the pattern extraction unit 14 will be described in detail later.

The output unit 15 outputs a form specified by the form designer to a display unit 29 or the like, and in the case where the form designer selects an item on the output form, the output unit 15 references the pattern table 6 stored in the correction information DB 16 and outputs the character string entry pattern(s) corresponding to the selected item.

In the case where the form designer selects at least one entry pattern from among the output character string entry pattern(s), the OCR unit 12 assigns the character string entry pattern selected by the form designer to the selected item of the form. Thereafter, in the case of executing an OCR process on a received image of the form, the OCR unit 12 performs character string recognition by referencing the character string entry pattern assigned to each item of the form.

Next, an exemplary schematic configuration of an electrical system in the information processing device 10 will be described.

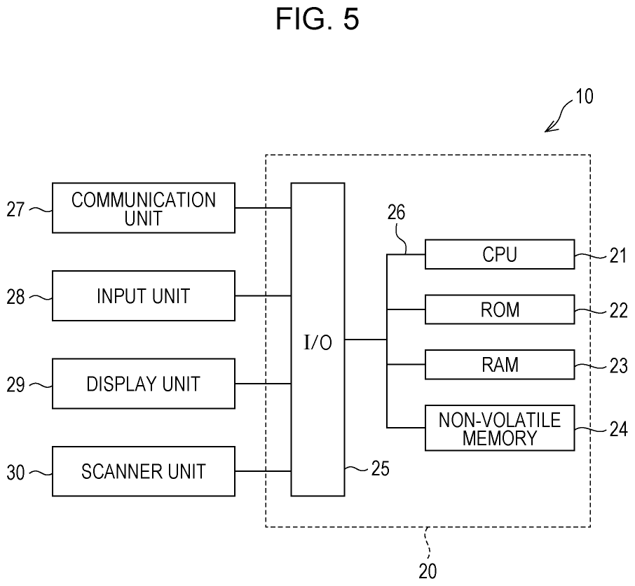

FIG. 5 is a diagram illustrating an exemplary schematic configuration of the electrical system in the information processing device 10. The information processing device 10 includes a computer 20, for example.

The computer 20 is provided with a central processing unit (CPU) 21, which is one example of a processor responsible for each functional unit according to the wearable device 10, read-only memory (ROM) 22 that stores an information processing program causing the computer 20 to function as each functional unit illustrated in FIG. 1, random access memory (RAM) 23 used as a temporary work area of the CPU 21, non-volatile memory 24, and an input/output interface (I/O) 25. Additionally, the CPU 21, ROM 22, RAM 23, non-volatile memory 24, and I/O 25 are interconnected through a bus 26.

The non-volatile memory 24 is one example of a storage device that retains stored information even if electric power supplied to the non-volatile memory 24 is cut off. Semiconductor memory is used for example, but a hard disk may also be used. The non-volatile memory 24 is not necessarily required to be built into the computer 20, and a portable storage device that is removable from the computer 20, such as a memory card for example, may also be used.

A communication unit 27, an input unit 28, a display unit 29, and a scanner unit 30 are connected to the I/O 25, for example.

The communication unit 27 is connected to a communication channel not illustrated, and is provided with a communication protocol that executes data communication with external devices connected to the communication channel not illustrated.

The input unit 28 is a device that receives instructions from the reviewer and the form designer, and notifies the CPU 21 of the instructions. For example, devices such as buttons, a touch panel, a keyboard, and a mouse are used for the input unit 28. In the case of issuing instructions by speech, a microphone may also be used as the input unit 28.

The display unit 29 is a device that displays information processed by the CPU 21. For example, a device such as a liquid crystal display or an organic electroluminescence (EL) display is used for the display unit 29.

The scanner unit 30 optically reads a form into which content has been entered by a person filling out the form, and generates an image of the form. Note that the scanner unit 30 is not strictly necessary in the information processing device 10, and the information processing device 10 may also acquire an image of a form read by a scanner device connected to a communication channel not illustrated through the communication unit 27.

The units connected to the I/O 25 are not limited to the units illustrated in FIG. 5, and other units, such as an image forming unit that forms an image on a recording medium for example, may also be connected. Also, semiconductor memory such as a memory card or Universal Serial Bus (USB) memory for example may be used to acquire an image of a form.

Next, operations of the information processing device 10 that extracts a character string entry pattern on the basis of the confirmation and correction table 2 will be described.

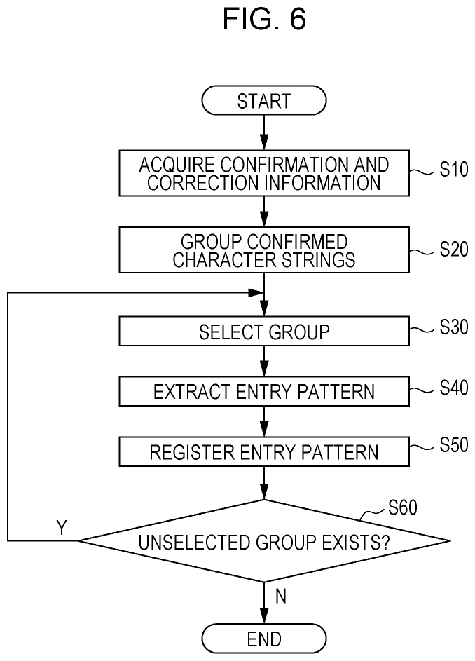

FIG. 6 is a flowchart illustrating one example of an extraction process executed by the CPU 21 of the information processing device 10 in the case of extracting an entry pattern of a character string entered into an item of a form. An information processing program stipulating the extraction process is stored in advance in the ROM 22 of the information processing device 10, for example. The CPU 21 of the information processing device 10 reads out the information processing program stored in the ROM 22 and executes the extraction process.

Note that there are no restrictions on the execution timing of the extraction process, and the CPU 21 may execute the extraction process at any timing. For example, the CPU 21 may execute the extraction process every time the OCR process is performed on an image of a form. Herein, as an example, it is assumed that the CPU 21 executes the extraction process on a predetermined interval, such as monthly for example. It is assumed that before the CPU 21 executes the extraction process illustrated in FIG. 6, the CPU 21 removes all pattern information from the pattern table 6.

The extraction process illustrated in FIG. 6 illustrates an example of extracting a character string entry pattern for any one item of a form. By executing the extraction process illustrated in FIG. 6 for each item of the form, character string entry patterns are respectively extracted for each item of all forms subjected to the OCR process.

In step S10, the CPU 21 acquires all confirmation and correction information for an item selected from a form (hereinafter referred to as the “selected item”) from the confirmation and correction table 2.

In step S20, the CPU 21 extracts confirmed character strings from the “confirmation and correction result” field of each piece of confirmation and correction information acquired in step S10, and sorts the confirmed character strings by character code. Furthermore, the CPU 21 aggregates the sorted and confirmed character strings into groups from the perspectives of prefix match and suffix match.

Specifically, the CPU 21 examines the sorted and confirmed character strings from beginning to end, aggregates confirmed character strings having the same number of characters matching consecutively from the beginning into the same groups, and counts the number of confirmed character strings included in each of the groups.

Next, the CPU 21 examines the sorted and confirmed character strings from end to beginning, aggregates confirmed character strings having the same number of characters matching consecutively from the end into the same groups, and counts the number of confirmed character strings included in each of the groups.

In step S30, the CPU 21 selects an unselected group that has not been selected yet from among the groups generated in step S20. The group selected in step S30 is referred to as the “selected group”.

In step S40, the CPU 21 extracts a character string entry pattern from the character string match conditions in the selected group.

For example, in the case where the selected group is a group of prefix-matching character strings in which the first three characters match, a character string entry pattern expressed by a regular expression, such as “\hat{ }A{3}” if the matching characters are “AAA”, is extracted. Also, in the case where the selected group is a group of suffix-matching character strings in which the last four characters match, a character string entry pattern expressed by a regular expression, such as “De{3}$” if the matching characters are “Deee”, is extracted.

Also, the CPU 21 computes the number of confirmed character strings included in the selected group with respect to the number of pieces of confirmation and correction information acquired in step S10 as the similarity.

In step S50, the CPU 21 registers, in the pattern table 6, pattern information associating the form name and the item name for which the character string entry pattern is extracted, the character string entry pattern extracted in step S40, and the computed similarity.

In step S60, the CPU 21 determines whether or not an unselected group that has not been selected in step S30 exists among the groups aggregated in step S20. In the case where one or more unselected groups exist, the flow proceeds to step S30, and one of the unselected groups is selected. By repeatedly executing the process from step S30 to step S60 until there are no more unselected groups, multiple character string entry patterns are set for the selected item.

On the other hand, in the case where the determination process in step S60 determines that an unselected group does not exist, the extraction process in FIG. 6 ends.

In FIG. 6, character string entry patterns are extracted from the confirmed character strings, but the perspective of extracting character string entry patterns is not limited to the match conditions of the confirmed character strings. The CPU 21 references all of the confirmation and correction information acquired in step S10 to analyze the features of the confirmed character strings from the perspective of various classification attributes, and determines whether a character string entry pattern is discovered.

Classification attributes refer to categories to focus on for extracting character string entry patterns from confirmed character strings, and examples of classification attributes include not only the match conditions of the confirmed character strings described above, but also the occurrence conditions of character types.

Character types refer to the notation patterns of the characters used in the confirmed character strings, and include types such as numerals, uppercase letters, lowercase letters, hiragana, and katakana. Particularly, in the case where the confirmed character strings are character strings printed by a device such as a printer, each of the numerals, uppercase letters, lowercase letters, and katakana have full-width and half-width variants.

In the case of focusing on the occurrence conditions of character types to extract character string entry patterns, in step S20 of FIG. 6, it is sufficient for the CPU 21 to extract a confirmed character string from each piece of confirmation and correction information acquired in step S10, and aggregate confirmed character strings having the same occurrence conditions of the character types in the confirmed character strings into groups.

Specifically, the CPU 21 examines the confirmed character strings from beginning to end, aggregates confirmed character strings having the same number of character types matching consecutively from the beginning into the same groups, and counts the number of confirmed character strings included in each of the groups.

Next, the CPU 21 examines the confirmed character strings from end to beginning, aggregates confirmed character strings having the same number of character types matching consecutively from the end into the same groups, and counts the number of confirmed character strings included in each of the groups.

Furthermore, in step S40 of FIG. 6, the CPU 21 extracts character string entry patterns from the occurrence conditions of character types in the selected group.

For example, in the case where the selected group is a group of confirmed character strings whose first three characters have a matching character type, and the matching character type is half-width uppercase letters, a character string entry pattern expressed by a regular expression such as “\hat{ }[A-Z]{3}” is extracted. Also, in the case where the selected group is a group of confirmed character strings whose first five characters have matching character types, and the matching character types are half-width uppercase letters for the first three characters and half-width lowercase letters for the fourth and fifth characters, a character string entry pattern expressed by a regular expression such as “\hat{ }[A-Z]{3}[a-z]{2}” is extracted.

Consequently, in step S50 of FIG. 6, it is sufficient for the CPU 21 to register, in the pattern table 6, pattern information associating the form name and the item name for which the character string entry pattern is extracted, the extracted character string entry pattern extracted, and the computed similarity.

With regard to a specific item of a form, in the case where the similarities are close for all of the extracted character string entry patterns, all of the character string entry patterns occur with approximately the same probability in the item of the form. In such a case, it is difficult to say that an extracted character string entry pattern is an entry pattern of a confirmed character that is representative of the item of the form in question.

Consequently, the CPU 21 may also register in the pattern table 6 just the character string entry pattern(s) for classification attributes recognized as having a significant difference among the extracted character string entry patterns. Herein, “having a significant difference among the extracted character string entry patterns” means being greater than a predetermined determination value indicating that if the difference in the similarities between the character string entry patterns is any larger, there is a representative character string entry pattern that tends to be used by persons filling out the form compared to the other character string entry patterns. Note that the similarities being close between character string entry patterns refers to a state in which the difference between the similarities of the character string entry patterns is equal to or less than the determination value.

Also, in the case of registering a character string entry pattern in the pattern table 6 in step S50 of FIG. 6, the CPU 21 may also register in the pattern table 6 a degree of change in the number of corrected character strings that have been corrected by the reviewer in association with incorrect character recognition in the OCR process, which changes depending on the character string entry pattern set to the item of the form.

Specifically, for each character string entry pattern registered in the pattern table 6, the CPU 21 registers, in the pattern table 6, the number of character strings that are finalized without being correcting by the reviewer because of incorrect character recognition in the OCR process in the case where the character string entry pattern is set to the item of the form. With this arrangement, the number of corrected character strings that drops due to setting the character string entry pattern to the item of the form is registered in the pattern table 6.

The above means that, for each character string entry pattern registered in the pattern table 6, the number of corrected character strings that are corrected due to not setting the character string entry pattern to the item of the form is also registered in the pattern table 6.

The number of character strings that are finalized without being corrected by the reviewer if the character string entry pattern is set to the item of the form, or in other words, the number of character strings that will be corrected if the character string entry pattern is not set to the item of the form, is expressed by the number of corrected character strings in the group from which the character string entry pattern is extracted, for example.

Also, in the above description, the number of corrected character strings in each item of the form that changes depending on whether or not the character string entry pattern is set is registered in the pattern table 6, but the changing proportion of corrected character strings may also be registered. The changing proportion of corrected character strings is expressed as the proportion of the number of corrected character strings with respect to the number of confirmed character strings included in the group from which the character string entry pattern is extracted, for example.

In the extraction process illustrated in FIG. 6, for each item of the form, character string entry patterns are extracted by using all of the confirmation and correction information registered in the confirmation and correction table 2 corresponding to the item. However, in the case of executing the extraction process illustrated in FIG. 6 at intervals of a predetermined period (such as one month) for example, the CPU 21 may also acquire just the confirmation and correction information registered in the confirmation and correction table 2 during the predetermined period, and at intervals of the predetermined period, acquire the number or proportion of corrected character strings that changes depending on character string entry pattern, the similarity, and whether or not the character string entry pattern is set. In this case, information expressing the period during which the character string entry pattern is extracted may also be included in the pattern information and managed by the pattern table 6.

Note that in the case of extracting character string entry patterns at intervals of a predetermined period, if the pattern information is not removed from the pattern table 6 before executing the extraction process illustrated in FIG. 6, the progression of changes in the pattern information in each period is obtained.

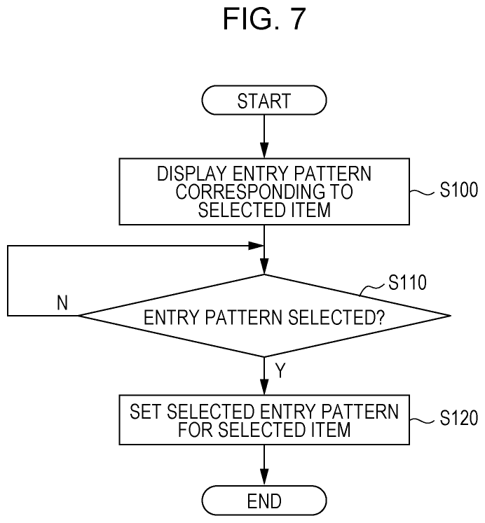

FIG. 7 is a flowchart illustrating one example of an output process executed by the CPU 21 of the information processing device 10 in a case where the form designer uses a device such as a mouse to select an item of a form displayed on a screen to set a character string entry pattern for the item of the form. An information processing program stipulating the output process is stored in advance in the ROM 22 of the information processing device 10, for example. The CPU 21 of the information processing device 10 reads out the information processing program stored in the ROM 22 and executes the output process.

Note that the following assumes that pattern information including the character string entry patterns extracted by the extraction process illustrated in FIG. 6 is already registered in the pattern table 6.

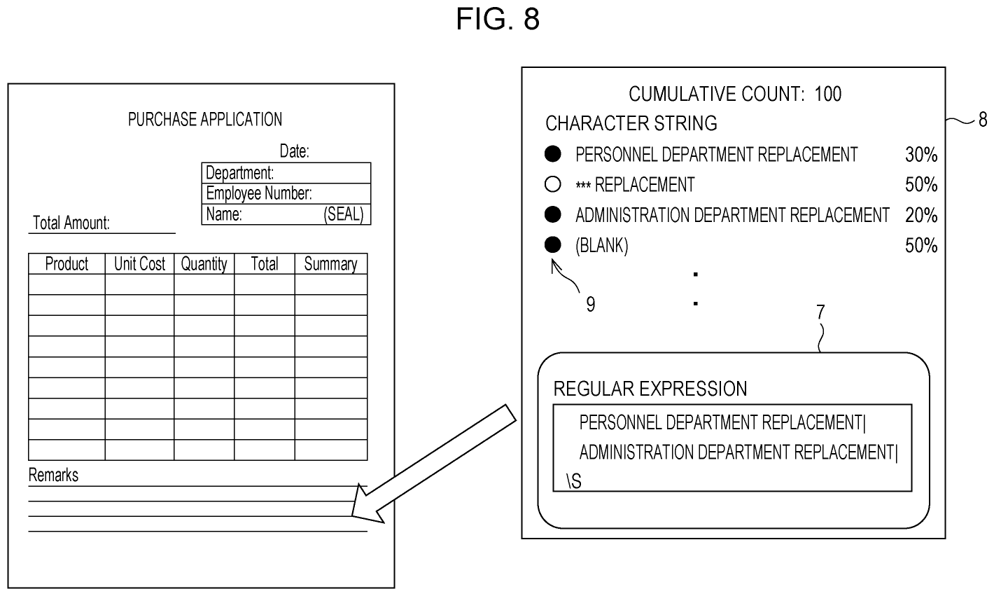

Meanwhile, FIG. 8 is a diagram illustrating an example of a screen displayed on the display unit 29 by the output process illustrated in FIG. 7. The output process illustrated in FIG. 7 will be described with reference to FIG. 8.

In step S100, the CPU 21 acquires the character string entry pattern corresponding to an item of the form selected by the form designer, that is, the selected item, from the pattern table 6, and displays the acquired character string entry pattern on the screen of the display unit 29.

The example of FIG. 8 illustrates a state in which the form designer has selected a “Remarks” field of a purchase application. In this case, the CPU 21 acquires pattern information in which the form name is set to “purchase application” and the item name is set to “remarks” from the pattern table 6, and displays a dialog 8 displaying each character string entry pattern and each similarity included in the pattern information on the screen. If multiple pieces of corresponding pattern information exist, the CPU 21 displays all character string entry patterns and similarities included in each piece of corresponding pattern information in the dialog 8. The CPU 21 may display the character string entry patterns as regular expressions, but may also convert the meaning expressed by the regular expression to a word or phrase for display. The “(Blank)” field in the dialog 8 of FIG. 8 is one example of expressing the regular expression “\s” of a character string entry pattern into a word or phrase.

In the case of displaying character string entry patterns in the dialog 8, the CPU 21 may also reference the similarities, sort the character string entry patterns such that the similarity falls from top to bottom (descending order) or such that the similarity rises from top to bottom (ascending order), and display the sorted character string entry patterns in the dialog 8. Additionally, the CPU 21 may also reference the cumulative count table 4 and display the cumulative count of confirmed character strings collected so far for the selected item in the dialog 8, and furthermore, the CPU 21 may also display the cumulative count of the confirmed character strings collected within a predetermined period (such as in the past month) from among the confirmed character strings collected so far, for example. For this reason, for example, date and time information about when character recognition results from the OCR process are confirmed by the reviewer may be included in the confirmation and correction information and managed by the CPU 21 in the confirmation and correction table 2, or the number of confirmed character strings collected for each item of the form may be totaled at intervals of a predetermined period and managed by the CPU 21 in the cumulative count table 4.

The form designer selects one or more desired character string entry patterns to set to the selected item from among the character string entry patterns displayed in the dialog 8, and confirms the selected content by pressing an OK button not illustrated. The dialog 8 includes check boxes 9 for selecting the character string entry patterns. For example, the check box 9 corresponding to a selected character string entry pattern is filled in black.

The CPU 21 displays the selected character string entry pattern(s) in a selection notification region 7 provided in the dialog 8 for example. In the case where multiple character string entry patterns are selected, the CPU 21 displays the combination of selected character string entry patterns expressed as a regular expression in the selection notification region 7. In the example of FIG. 8, “Personnel department replacement”, “Administration department replacement” and “(Blank)” are selected, and therefore a regular expression expressed like “Personnel department replacement|Administration department replacement|\s” is displayed in the selection notification region 7.

In step S110, the CPU 21 determines whether or not a character string entry pattern has been selected by the form designer. In the case where a character string entry pattern has not been selected, the determination process in step S110 is executed repeatedly to monitor the status of the selection of a character string entry pattern by the form designer. On the other hand, in the case in which at least character string entry pattern has been selected, the flow proceeds to step S120.

In step S120, the CPU 21 sets the selected character string entry pattern(s) to the selected item. With the above, the output process illustrated in FIG. 7 ends.

Note that in the dialog 8, a variety of information is displayed together with the character string entry patterns corresponding to the selected item.

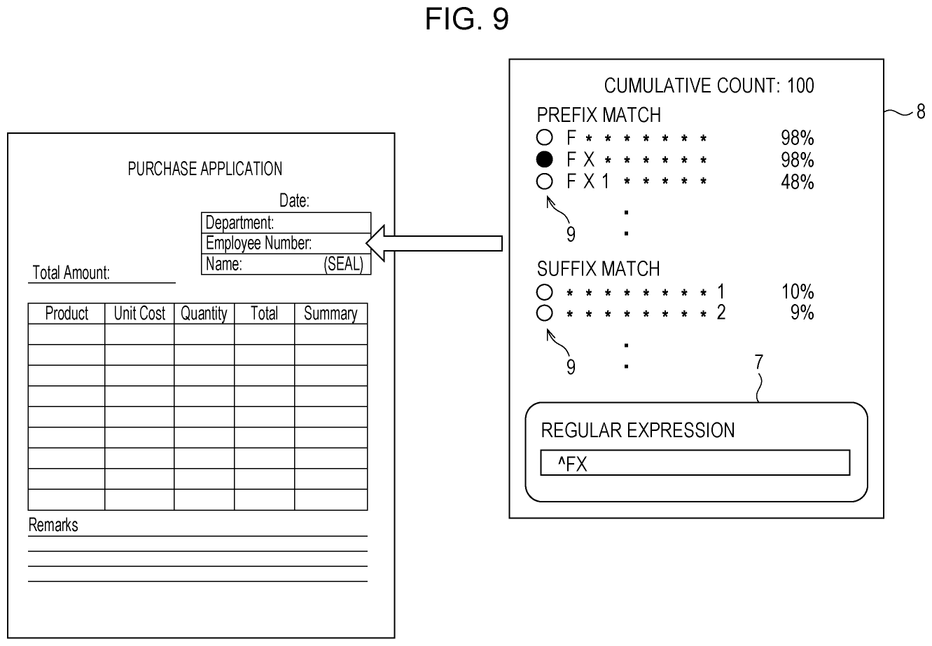

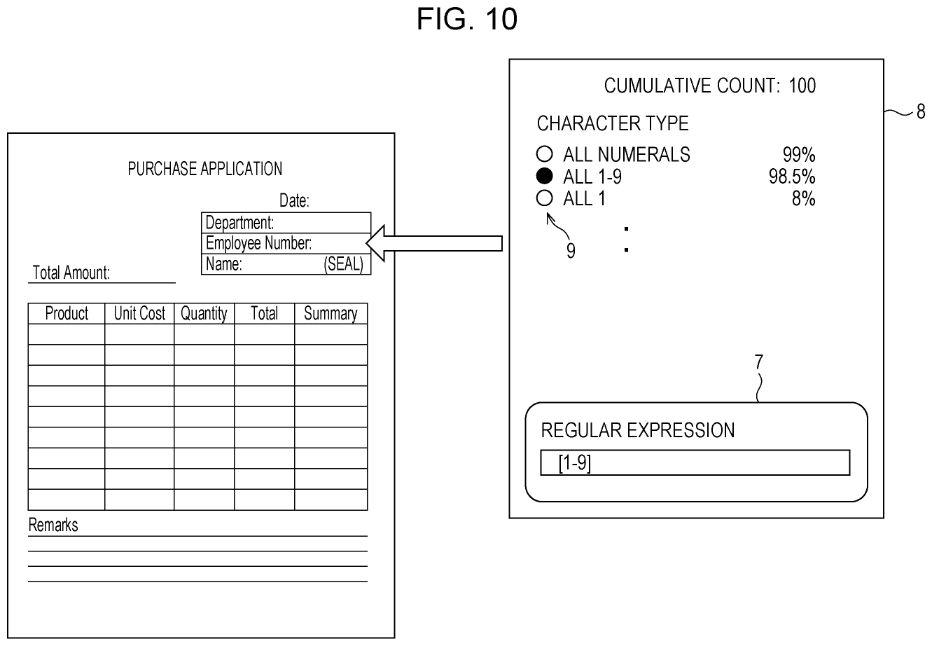

For example, as illustrated in FIG. 9, the character string entry patterns may be displayed divided into prefix-matching and suffix-matching entry patterns, or as illustrated in FIG. 10, in the case where character string entry patterns extracted from the occurrence conditions of character types exist, “Character Type” may be displayed, and the meaning expressed by the regular expression corresponding to each character string entry pattern may be displayed as a word or phrase.

Also, if a character string entry pattern having a standard similarity or higher exists, to distinguish the character string entry pattern having the standard similarity or higher from the other character string entry patterns, in the case of displaying the dialog 8, the CPU 21 may cause the character string entry pattern having the standard similarity or higher to be presented differently from the other character string entry patterns. Specifically, the CPU 21 alters at least one display characteristic such as the font color, the background color, the font size, and the font face.

Furthermore, the CPU 21 may display other information registered in the pattern table 6 for each character string entry pattern, such as the number of character strings that are finalized without being corrected if the character string entry pattern is set to the item of the form, or in other words, the number of corrected character strings that will be corrected if the character string entry pattern is not set to the item of the form, for example.

In this way, according to the information processing device 10 according to the exemplary embodiment, character string entry patterns are extracted from confirmed character strings for each item of a form confirmed by the reviewer, and in the case where the form designer attempts to set any of the character string entry patterns to an item of the form, the character string entry pattern(s) corresponding to the item of the form selected by the form designer is output.

Consequently, the form designer is able to save the time and effort of thinking about which character string entry pattern to set to an item of the form by him- or herself. Furthermore, because the information processing device 10 generates each character string entry pattern as a regular expression, even if the form designer does not understand the regular expression, by selecting a desired character string entry pattern to set for an item of a form by looking at a word or phrase describing the content of the regular expression displayed on the dialog 8 for example, the regular expression corresponding to the selected content is set to the item of the form.

Also, character string entry patterns may be presented even for an item in which a character string entry pattern is deliberately not set because the form designer looks at the content of an item and thinks that an entry pattern does not exist for the content entered by persons filling out the form, and therefore a character string entry pattern may still be set for such an item of the form in some cases. Additionally, in some cases, the information processing device 10 presents a character string entry pattern that the form designer did not notice by him- or herself. If a presented character string entry pattern is expected to raise the certainty factor of character strings recognized by the OCR process over a character string entry pattern already set to an item of a form, the form designer saves the time and effort of personally examining which character string entry patterns have an effect of raising the certainty factor.

### Exemplary Modification 1

In the extraction process illustrated in FIG. 6, character string entry patterns are extracted from collected confirmed character strings, irrespectively of the number of confirmed character strings collected for an item of a form. However, if there is only one confirmed character string collected for the item of the form being targeted for the extraction of character string entry patterns, for example, it will be difficult to determine whether a character string entry pattern extracted from the confirmed character string is an entry pattern that is representative of the item of the form being targeted for the extraction of character string entry patterns.

Consequently, the exemplary modification describes an information processing device 10 that specifies whether or not the extraction of character string entry patterns is available, depending on the number of confirmed character strings collected for the item of the form being targeted for the extraction of character string entry patterns.

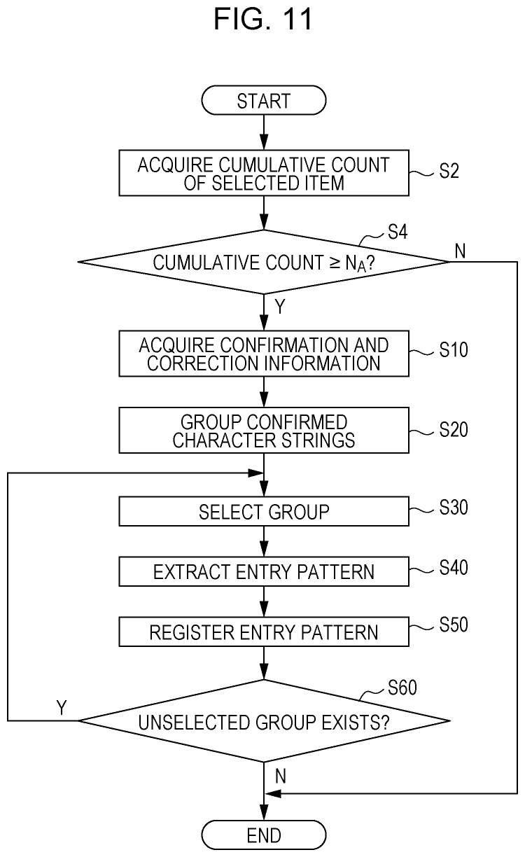

FIG. 11 is a flowchart illustrating an exemplary modification of the extraction process executed by the CPU 21 of the information processing device 10 in the case of extracting an entry pattern of a character string entered into an item of a form. The extraction process illustrated in FIG. 11 differs from the extraction process illustrated in FIG. 6 in that steps S2 and S4 are added, but otherwise the process is the same as the extraction process illustrated in FIG. 6. Consequently, the following description will focus on the processing in steps S2 and S4.

In step S2, the CPU 21 references the cumulative count table 4 and acquires the cumulative count of the confirmed character strings corresponding to the selected item.

In step S4, the CPU 21 determines whether or not the cumulative count acquired in step S10 is equal to or greater than a predetermined standard count N_{A}. The “standard count N_{A}” is the cumulative count of a minimum number of confirmed character strings that is enough to ensure the reliability of a character string entry pattern extracted from the confirmed character strings, and is one example of a number predetermined as a number from which a regularity in the confirmed character strings is extracted. The standard count N_{A} is preset from a statistical point of view, for example, and is stored in the non-volatile memory 24. Note that the standard count N_{A} is corrected according to an instruction from the form designer or the like.

If the number of confirmed character strings for the selected item is equal to or greater than the standard count N_{A}, the reliability of character string entry patterns extracted from this point on is ensured, and therefore the flow proceeds to step S10, and the extraction process described in FIG. 6 is executed.

On the other hand, in the case where the determination process in step S4 determines that the number of confirmed character strings for the selected item is less than the standard count N_{A}, the reliability of character string entry patterns extracted from this point on is still uncertain, and therefore the extraction process illustrated in FIG. 11 ends without extracting character string entry patterns.

Obviously, in the case of extracting character string entry patterns from confirmed character strings collected at intervals of a predetermined period, character string entry patterns are extracted in the case where the cumulative count of confirmed character strings collected over a single period, and not the total cumulative count of confirmed character strings collected over all periods, is equal to or greater than the standard count N_{A}.

### Exemplary Modification 2

Even if a character string entry pattern has already been set to an item of a form, a situation may occur in which it is beneficial to reexamine the set entry pattern. For example, in the case of a “part number” item of a form, a part number is entered into the entry field of the item, but in the case where the number scheme for part numbers is changed from a scheme that starts with a number to a scheme that starts with a letter, the character string entry pattern that had been set before the number scheme changed is no longer compatible with the new number scheme for part numbers, and reexamination of the character string entry pattern is beneficial. However, the form designer is not necessarily informed of events that influence character string entry patterns, such as changes to a number scheme, and as a result, situations may occur in which a character string entry pattern that is no longer compatible with the actual content entered into an item remains set for the item.

Consequently, the exemplary modification describes an information processing device 10 that detects a situation in which it is beneficial to change a character string entry pattern set to an item of a form, and outputs a change notification encouraging the form designer to change the character string entry pattern.

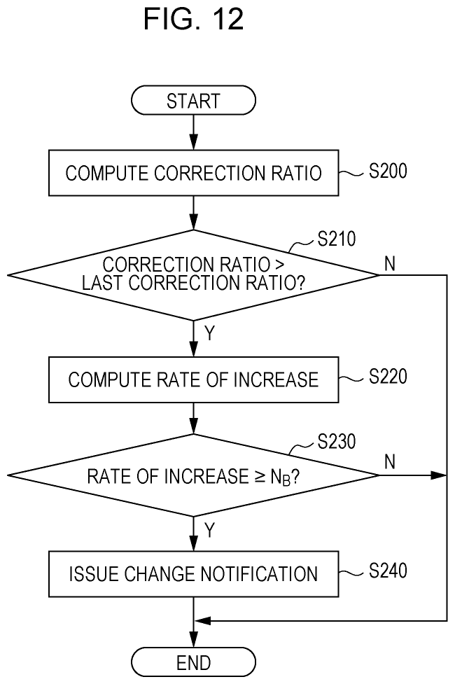

FIG. 12 is a flowchart illustrating one example of a change notification process executed by the CPU 21 of the information processing device 10. The CPU 21 may execute the change notification process at any timing. Herein, as an example, it is assumed that the CPU 21 executes the extraction process illustrated in FIG. 6 or FIG. 11 at intervals of a predetermined period, and executes the change notification process in coordination with the execution of the extraction process. For the sake of convenience, a period that is the target of the change notification process is referred to as the “target period”.

Note that although the change notification process illustrated in FIG. 12 illustrates an example of determining the demand for a change notification with respect to any one item of a form, by executing the change notification process illustrated in FIG. 12 for every item of each form, the demand for a change notification is determined with respect to each item of all forms subjected to the OCR process.

In step S200, the CPU 21 computes a correction ratio of the target period. The correction rate is the proportion of corrected character strings among the confirmed character strings collected during the target period. For example, if the predetermined period is one month, the correction ratio is computed monthly.

In step S210, the CPU 21 determines whether or not the correction ratio of the target period computed in step S200 is higher than the correction ratio computed in a period (referred to as the comparison period) earlier than the target period. To determine the demand for a change notification from the most recent change in the correction ratio, it is desirable to make the comparison period a period adjacent to the target period. For example, if the target period is August, the comparison period is set to July. In the case where the correction ratio of the target period is higher than the correction ratio of the comparison period, the flow proceeds to step S220.

In step S220, the CPU 21 computes the rate of increase of the correction ratio in the target period based on the correction ratio in the comparison period. In other words, the correction ratio of the target period is one example of a standard degree.

In step S230, the CPU 21 determines whether or not the rate of increase computed in step S220 is equal to or greater than a standard rate of increase N_{B}. The “standard rate of increase N_{B}” refers to a minimum rate of increase beyond which a reexamination of the character string entry pattern set to the selected item is considered to be beneficial. The standard rate of increase N_{B} is pre-stored in the non-volatile memory 24 for example, and is corrected according to an instruction from the form designer or the like.

In the case where a change occurs in the content entered in the entry field of an item, like in the case where the number scheme for part numbers is changed for example, because a character string entry pattern corresponding to the new entry content has not yet been set to the item, the correction ratio rises compared to before the change in the entry content. Consequently, monitoring the rate of increase in the correction ratio makes it possible to determine whether or not a reexamination of the character string entry pattern set to the selected item is demanded.

In the case where the rate of increase computed in step S220 is equal to or greater than the standard rate of increase N_{B}, the flow proceeds to step S240.

In this case, because the rate of increase is equal to or greater than the standard rate of increase N_{B}, a reexamination of the character string entry pattern set to the selected item is considered to be beneficial. Consequently, in step S240, the CPU 21 outputs a change notification, and the change notification process illustrated in FIG. 12 ends. There are no restrictions on the method of outputting the change notification insofar the form designer is able to notice the change notification. For example, information encouraging the form designer to change the character string entry pattern may be displayed on the screen of the display unit 29 or transmitted to an email address assigned to a portable device such as a smartphone carried by the form designer.

On the other hand, in the case where the determination process in step S210 determines that the correction ratio of the target period is equal to or less than the correction ratio of the comparison period, or in the case where the determination process in step S230 determines that the rate of increase of the correction ratio in the target period is less than the standard rate of increase N_{B}, a change notification is not output, and the change notification process illustrated in FIG. 12 ends.

Note that in the case where a character string entry pattern set by the form designer is an ineffective character string entry pattern that would not influence the certainty factor of recognized character strings even if set, it is not necessary to set the character string entry pattern in the item of the form. Also, if such ineffective character string entry patterns are set to the item of the form as-is, it may become difficult to understand which character string entry pattern is effective at improving the certainty factor.

Consequently, the CPU 21 may compare the correction ratios in the periods before and after a character string entry pattern is set to the item of the form, and in the case where the difference in the correction ratio is included within a predetermined range, the CPU 21 may output a change notification encouraging the form designer to remove the character string entry pattern that only slightly changes the correction ratio within the predetermined range before and after being set. In this case, the CPU 21 outputs a change notification that also includes the ineffective character string entry pattern.

In this way, according to the information processing device 10 according to the exemplary modification, the demand for a change is determined from the degree of change in the correction ratio, and a change notification is output as appropriate. Consequently, an opportunity for reexamining the character string entry patterns may be provided to the form designer who has not noticed a change in the entry content for an item of a form. Because character string entry patterns indicating the trend of confirmed character strings after a change in the entry content are also presented by the information processing device 10, the form designer is able to simply select a desired entry pattern to set from among the presented character string entry patterns to complete the reexamination of the character string entry patterns.

Also, because ineffective character string entry patterns are also presented, the form designer is able to simply remove the presented character string entry patterns to tidy up the character string entry patterns set to an item of a form.

The foregoing exemplary embodiment describes an example in which the information processing device 10 presents character string entry patterns to the form designer, but the information processing device 10 may also select an appropriate character string entry pattern from among the extracted character string entry patterns, and set the selected character string entry pattern to an item of a form. For an appropriate character string entry pattern, it is sufficient to select a character string entry pattern whose similarity is equal to or greater than the standard similarity and for which the number of character strings that are finalized without being corrected is equal to or greater than a predetermined number if the character string entry pattern is set to the item of the form, for example. Additionally, the information processing device 10 may also execute the reexamination of character string entry patterns autonomously, without waiting for an instruction from the form designer.

Also, the exemplary embodiment is described by taking an example of the information processing device 10 that includes functional units of the reading unit 11, the OCR unit 12, the confirmation and correction unit 13, the pattern extraction unit 14, and the output unit 15 as well as the correction information DB 16, but an information processing device 10 that includes only the pattern extraction unit 14 and the output unit 15 may also be used to achieve a process according to the exemplary embodiment. Specifically, it is sufficient to provide the functional units of the reading unit 11, the OCR unit 12, and the confirmation and correction unit 13 as well as the correction information DB 16 in an external device, communicate with the external device through the communication unit 27, cause the pattern extraction unit 14 to reference the confirmation and correction table 2 and the cumulative count table 4 included in the correction information DB 16 provided in the external device, and set and reference the pattern table 6.

The foregoing describes the present disclosure using an exemplary embodiment, but the present disclosure is not limited to the scope described in the exemplary embodiment. Various modifications or alterations may be made to the foregoing exemplary embodiment within a scope that does not depart from the gist of the present disclosure, and any embodiments obtained by such modifications or alterations are also included in the technical scope of the present disclosure. For example, the order of processes may be modified without departing from the gist of the present disclosure.

The exemplary embodiment describes a configuration in which the extraction process, the output process, and the change notification process are achieved by software as an example, but processes that are substantially the same as each of the flowcharts illustrated in FIGS. 6, 7, 11, and 12 may also be implemented in an application-specific integrated circuit (ASIC), a field-programmable gate array (FPGA), or a programmable logic device (PLD) and processed by hardware, for example. In this case, a speedup may be attained compared to the case of achieving the confirmation and correction process by software.

In this way, the CPU 21 may be replaced by a special-purpose processor specialized for a specific process, such as an ASIC, an FPGA, a PLD, a graphics processing unit (GPU), or a floating point unit (FPU), for example.

In the embodiment above, the term “processor” refers to hardware in a broad sense. Examples of the processor include general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment(s) above, and may be changed.

Also, the foregoing exemplary embodiment describes a configuration in which the information processing program is installed in the ROM 22, but is not limited thereto. The information processing program according to the present disclosure may also be provided by being recorded on a computer-readable storage medium. For example, the information processing program according to the present disclosure may be provided by being recorded on an optical disc, such as a Compact Disc-Read-Only Memory (CD-ROM) or a Digital Versatile Disc-Read-Only Memory (DVD-ROM). Also, the information processing program according to the present disclosure may be provided by being recorded on semiconductor memory.

Furthermore, the information processing device 10 may also acquire the information processing program according to the present disclosure from an external device through a communication channel not illustrated.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
output an extracted character string entry rule for each item of a form in a case where a regularity related to an entry of a character string of a confirmation result is extracted, the confirmation result being a result of confirming a result of character recognition performed on the form.

2. The information processing device according to claim 1, wherein the processor is configured to:
output the character string entry rule together with a degree of change in a number of corrected character strings that have been corrected in association with incorrect character recognition that changes depending on whether or not the character string entry rule is set.

3. The information processing device according to claim 2, wherein the processor is configured to:
output a degree of change in the number of corrected character strings that falls if the output character string entry rule is set to the item of the form.

4. The information processing device according to claim 2, wherein the degree of change is a degree of the number of corrected character strings that are corrected due to the output character string entry rule not being set to the item of the form as the degree of change.

5. The information processing device according to claim 1, wherein the processor is configured to:
output the character string entry rule with respect to a classification attribute by which a regularity related to the entry of a character string is extracted.

6. The information processing device according to claim 2, wherein the processor is configured to:
output the character string entry rule with respect to a classification attribute by which a regularity related to the entry of a character string is extracted.

7. The information processing device according to claim 3, wherein the processor is configured to:
output the character string entry rule with respect to a classification attribute by which a regularity related to the entry of a character string is extracted.

8. The information processing device according to claim 4, wherein the processor is configured to:
output the character string entry rule with respect to a classification attribute by which a regularity related to the entry of a character string is extracted.

9. The information processing device according to claim 5, wherein the processor is configured to:
output the character string entry rule for the classification attribute recognized as having a significant difference among a plurality of character string entry rules extracted from the character string of the confirmation result.

10. The information processing device according to claim 1, wherein the processor is configured to:
specify whether or not a regularity related to the entry of a character string is extracted from the character string of the confirmation result, according to the number of character strings of the confirmation result collected for the item of the form.

11. The information processing device according to claim 2, wherein the processor is configured to:
specify whether or not a regularity related to the entry of a character string is extracted from the character string of the confirmation result, according to the number of character strings of the confirmation result collected for the item of the form.

12. The information processing device according to claim 3, wherein the processor is configured to:
specify whether or not a regularity related to the entry of a character string is extracted from the character string of the confirmation result, according to the number of character strings of the confirmation result collected for the item of the form.

13. The information processing device according to claim 4, wherein the processor is configured to:
specify whether or not a regularity related to the entry of a character string is extracted from the character string of the confirmation result, according to the number of character strings of the confirmation result collected for the item of the form.

14. The information processing device according to claim 10, wherein the processor is configured to:
in a case where the number of character strings of the confirmation result collected for the item of the form is equal to or greater than a number predetermined as a number from which the regularity is extracted, output the character string entry rule for the item whose number of character strings of the confirmation result is the predetermined number or greater.

15. The information processing device according to claim 10, wherein the processor is configured to:
in a case where the number of character strings of the confirmation result collected for the item of the form is less than a number predetermined as a number from which the regularity is extracted, not output the character string entry rule for the item whose number of character strings of the confirmation result is less than the predetermined number.

16. The information processing device according to claim 1, wherein the processor is configured to:
output a change notification encouraging a user to change the character string entry rule set to the item of the form according to a degree of correction with respect to the character string entered in the item of the form.

17. The information processing device according to claim 16, wherein the processor is configured to:
output the change notification in a case where the degree of correction in the item of the form has become equal to or greater than a degree predetermined from a standard degree.

18. The information processing device according to claim 16, wherein the processor is configured to:
output the change notification in a case where the degree of correction in an item of the form after setting a character string entry rule is included within a range predetermined from the degree of correction for the same item of the form before setting the character string entry rule.

19. A non-transitory computer readable medium storing a program causing a computer to execute a process for processing information, the process comprising:
outputting an extracted character string entry rule for each item of a form in a case where a regularity related to an entry of a character string of a confirmation result is extracted, the confirmation result being a result of confirming a result of character recognition performed on the form.
